(19) United States
(12) Patent Application Publication
(10) Pub. No.: US 2023/0299311 A1
(43) Pub. Date: Sep. 21, 2023

(54) BATTERY SYSTEM

(71) Applicant: DENSO CORPORATION, Kariya-city (JP)

(72) Inventor: Takashi YAMADA, Kariya-city (JP)

(21) Appl. No.: 18/324,047

(22) Filed: May 25, 2023

Related U.S. Application Data
(63) Continuation of application No. PCT/JP2021/040608, filed on Nov. 4, 2021.

(30) Foreign Application Priority Data
Nov. 27, 2020 (JP) 2020-197410

(51) Int. Cl. H01M 8/0267; H01M 8/0438; H01M 8/0432; H01M 8/04746

(52) U.S. Cl. CPC H01M 8/0267; H01M 8/04417; H01M 8/04358; H01M 8/04768

(57) ABSTRACT

A battery system cools a battery device by supplying a coolant to the battery device. The battery system includes a coolant flow path through which the coolant circulates, a coolant pump to control a flow of the coolant passing through the coolant flow path to circulate the coolant between the battery device and the coolant flow path, a differential pressure sensor to detect a differential pressure between a pressure of the coolant passing through a coolant supply port from the coolant flow path to the battery device and a pressure of the coolant passing through a coolant discharge port from the battery device to the coolant flow path, and a controller to determine whether there is a leakage of the coolant based on a comparison between the differential pressure acquired from the differential pressure sensor and an estimated value stored in advance.

### CROSS REFERENCE TO RELATED APPLICATIONS

The present application is a continuation application of International Patent Application No. PCT/JP2021/040608 filed on Nov. 4, 2021, which designated the U.S. and claims the benefit of priority from Japanese Patent Application No. 2020-197410 filed on Nov. 27, 2020. The entire disclosures of all of the above applications are incorporated herein by reference.

### TECHNICAL FIELD

The present disclosure relates to a battery system for cooling a battery.

### BACKGROUND

A fuel cell system detects leakage of a coolant of a fuel cell.

### SUMMARY

According to at least one embodiment, a battery system can cool a battery device by supplying a coolant to the battery device. The battery system includes a coolant flow path through which the coolant circulates, a coolant pump to control a flow of the coolant passing through the coolant flow path to circulate the coolant between the battery device and the coolant flow path, a differential pressure sensor to detect a differential pressure between a pressure of the coolant passing through a coolant supply port from the coolant flow path to the battery device and a pressure of the coolant passing through a coolant discharge port from the battery device to the coolant flow path, and a determination unit to determine whether there is a leakage of the coolant based on a comparison between the differential pressure acquired from the differential pressure sensor and an estimated value stored in advance.

### BRIEF DESCRIPTION OF DRAWINGS

The details of one or more embodiments are set forth in the accompanying drawings and the description below. Other features and advantages will be apparent from the description and drawings, and from the claims.

FIG. 1 is a diagram showing a fuel cell system;

FIG. 2 is a flowchart showing a detection process;

FIG. 3 is a diagram showing a relationship between a coolant flow rate and a differential pressure;

FIG. 4 is (a) a time chart showing a change in differential pressure, (b) a time chart showing a change in rotation speed and power consumption, and (c) a time chart showing a leakage amount of a coolant;

FIG. 5 is a diagram showing a fuel cell system according to a second embodiment;

FIG. 6 is a flowchart showing a detection process according to the second embodiment;

FIG. 7 is a diagram showing a relationship between a coolant flow rate and a coolant pressure;

FIG. 8 is a diagram showing a fuel cell system according to a third embodiment;

FIG. 9 is a flowchart showing a detection process according to the third embodiment;

FIG. 10 is a diagram showing a fuel cell system according to a fourth embodiment;

FIG. 11 is a flowchart showing a detection process according to the fourth embodiment;

FIG. 12 is a diagram showing a fuel cell system according to a fifth embodiment; and

FIG. 13 is a flowchart showing a detection process according to the fifth embodiment.

### DETAILED DESCRIPTION

To begin with, examples of relevant techniques will be described.

A fuel system according to a comparative example is capable of accurately detecting leakage of a coolant of a fuel cell. In the fuel cell system, for detecting the leakage of the coolant, the coolant flowing in a coolant discharge path is channeled to a radiator flow path. Then, power consumption of a coolant pump is measured, and the leakage is detected based on the power consumption. By flowing the coolant through the radiator flow path, bubbles mixed in the coolant can be atomized. As a result, pulsation of power consumption can be reduced, and leakage of the coolant can be accurately detected.

In the fuel cell system, for detecting the leakage of the coolant, the coolant flowing in the coolant discharge path needs to be channeled to the radiator flow path. Therefore, even if it is not necessary to flow the coolant to the radiator flow path from a viewpoint of temperature adjustment of the coolant, the coolant needs to be channeled to the radiator flow path for detecting the leakage of the coolant. In this case, the temperature of the coolant may not be appropriately adjusted by flowing the coolant to the radiator flow path. In addition, when the coolant cannot flow to the radiator flow path, such as when air temperature is below freezing or before an opening degree of a valve for flowing the coolant to the radiator flow path is fully opened, the leakage of the coolant may not be detected. Further, the leakage may not be detected at a portion where the coolant does not pass when the coolant flows to the radiator flow path at the time of detection of the coolant, such as when the coolant leaks in a bypass flow path.

In contrast to the comparative example, according to a battery system of the present disclosure, an abnormality can be constantly monitored.

According to one aspect of the present disclosure, a battery system cools a battery device by supplying a coolant to the battery device. The battery system includes a coolant flow path through which the coolant circulates, a coolant pump to control a flow of the coolant passing through the coolant flow path to circulate the coolant between the battery device and the coolant flow path, a differential pressure sensor to detect a differential pressure between a pressure of the coolant passing through a coolant supply port from the coolant flow path to the battery device and a pressure of the coolant passing through a coolant discharge port from the battery device to the coolant flow path, and a determination unit to determine whether there is a leakage of the coolant based on a comparison between the differential pressure acquired from the differential pressure sensor and an estimated value stored in advance.

The entire amount of coolant passes through the coolant supply port and the coolant discharge port. Therefore, in the above configuration, the differential pressure sensor detects the differential pressure between the pressure of the coolant passing through the coolant supply port and the pressure of the coolant passing through the coolant discharge port, and the determination unit determines the leakage of the coolant based on the comparison between the differential pressure and the estimated value. Therefore, abnormality, for example the leakage of the coolant, of the battery system can be always determined.

Hereinafter, embodiments will be described with reference to the drawings. In the following embodiments and modifications, parts that are the same or equivalent to each other are denoted by the same reference numerals in the drawings, and the description of the parts denoted by the same reference numerals is referred to.

### First Embodiment

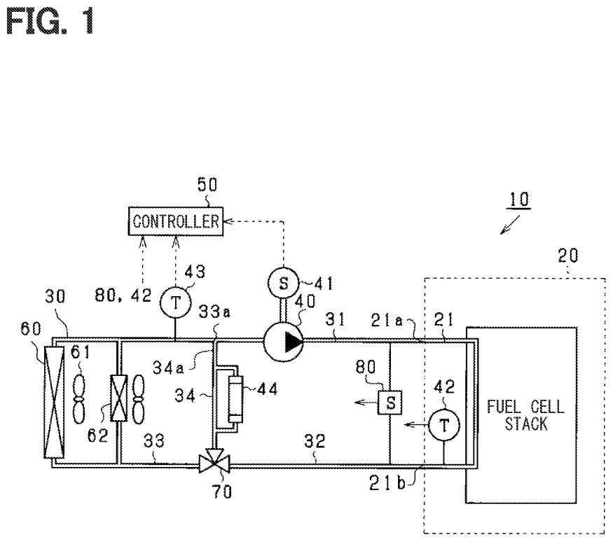

FIG. 1 shows a diagram showing a fuel cell system 10 as a battery system according to a first embodiment. The fuel cell system 10 includes a fuel cell 20 as a battery device, a coolant flow path 30 through which a coolant flows, a coolant pump 40 which is disposed in the coolant flow path 30 and circulates the coolant, and a controller 50 which controls the fuel cell system 10. The coolant flow path 30 is connected to the fuel cell 20. The coolant is, for example, an aqueous solution containing ethylene glycol.

The fuel cell 20 is, for example, a power generation source of a vehicle and includes a fuel cell stack that generates power by a chemical reaction between hydrogen and oxygen. More specifically, the fuel cell 20 takes in the hydrogen from a hydrogen tank filled with the hydrogen and the oxygen from the atmosphere to generate power. The fuel cell 20 includes an in-cell flow path 21 inside which the coolant flows. The coolant in the in-cell flow path 21 cools heat generated during power generation.

The coolant flow path 30 has a tubular shape, for example. The coolant flow path 30 includes a coolant supply path 31 connected to the coolant supply port 21a of the fuel cell 20, a coolant discharge path 32 connected to the coolant discharge port 21b of the fuel cell 20, a radiator flow path 33 connecting the coolant supply path 31 and the coolant discharge path 32, and a bypass flow path 34 disposed in parallel with respect to the radiator flow path 33.

The coolant supply path 31 is a flow path for supplying the coolant to the fuel cell 20. One end of the coolant supply path 31 is connected to a coolant supply port 21a for supplying the coolant to the fuel cell 20. The other end of the coolant supply path 31 is connected to one end 33a of the radiator flow path 33 and one end 34a of the bypass flow path 34. A coolant pump 40 is arranged at the coolant supply path 31.

The coolant pump 40 is a pump that circulates the coolant between the coolant flow path 30 and the fuel cell 20. An inflow port and an outlet port of the coolant pump 40 are connected to the coolant supply path 31. The coolant pump 40 sends the coolant flowing from the coolant supply path 31 via the inflow port to the coolant supply path 31 via the outlet port. The coolant pump 40 is controlled by the controller 50. A pump sensor 41 is attached to the coolant pump 40. The pump sensor 41 acquires information on rotation speed and power consumption of the coolant pump 40 and output the information to the controller 50.

The coolant discharge path 32 is a flow path through which the coolant is discharged from the fuel cell 20. One end of the coolant discharge path 32 is connected to a coolant discharge port 21b through which the coolant from the fuel cell 20 is discharged. The other end of the coolant discharge path 32 is connected to the radiator flow path 33 and the bypass flow path 34 via a rotary valve 70. A first temperature sensor 42 is arranged near the coolant discharge port 21b of the coolant discharge path 32. The first temperature sensor 42 detects coolant temperature of the coolant passing through the coolant discharge port 21b. Hereinafter, the coolant temperature is referred to as a first coolant temperature. The first temperature sensor 42 is connected to the controller 50 and outputs the detected first coolant temperature to the controller 50.

The radiator flow path 33 is a flow path through which the coolant supplied to the radiator 60 or the coolant supplied (discharged) from the radiator 60 flows. One end 33a of the radiator flow path 33 is connected to the coolant supply path 31, and the other end is connected to the coolant discharge path 32 via the rotary valve 70. A radiator 60 is arranged in the radiator flow path 33. A second temperature sensor 43 is arranged in the radiator flow path 33. The second temperature sensor 43 is shifted from the radiator 60 toward the coolant supply path 31. The second temperature sensor 43 detects coolant temperature of the coolant supplied or discharged from the radiator 60. Hereinafter, the coolant temperature is referred to as a second coolant temperature. The second temperature sensor 43 is connected to the controller 50 and outputs the detected second coolant temperature to the controller 50.

The radiator 60 is a heat exchanger that exchanges heat between the coolant flowing through the radiator flow path 33 and an outside air. More specifically, when the coolant flows in the radiator 60 from the radiator flow path 33, the flowing coolant releases heat to the outside air. And then, the cooled coolant flows out (returns) to the radiator flow path 33.

The radiator 60 has, for example, a structure in which the coolant flows in narrow tubes, or a structure in which the coolant flows in a meandering tube in order to increase surface area of contact between the coolant flowing inside and the outside air. The radiator 60 includes a radiator fan 61. The radiator fan 61 blows the outside air to the radiator 60. The radiator fan 61 is controlled by the controller 50. As shown in FIG. 1, a sub radiator 62 parallel to the radiator flow path 33 may or may not be provided.

The bypass flow path 34 is provided in parallel with the radiator flow path 33. One end 34a of the bypass flow path 34 is connected to the coolant supply path 31, and the other end is connected to the coolant discharge path 32 via the rotary valve 70. An ion exchanger 44 for removing impurity ions in the coolant is connected to the bypass flow path 34. The ion exchanger 44 may not be provided.

The rotary valve 70 is a valve device that distributes the coolant flowing through the coolant discharge path 32 to the bypass flow path 34 or the radiator flow path 33. The rotary valve 70 is controlled by the controller 50. For example, when the rotary valve 70 is fully opened to the bypass flow path 34, the coolant does not flow from the coolant discharge path 32 to the radiator flow path 33, and the entire amount of the coolant flows to the bypass flow path 34. On the other hand, when the rotary valve 70 is fully opened to the radiator flow path 33, the coolant does not flow from the coolant discharge path 32 to the bypass flow path 34, and the entire amount of the coolant flows to the radiator flow path 33. In addition, by adjusting an opening degree of the rotary valve 70, a part of the coolant passing through the coolant discharge path 32 is capable of flowing into the bypass flow path 34, and the remaining part is capable of flowing into the radiator flow path 33. In addition, how the coolant is distributed is also possible by adjusting the opening degree of the rotary valve 70.

A differential pressure sensor 80 is provided in the coolant flow path 30. The differential pressure sensor 80 detects a differential pressure between a pressure of the coolant passing through the coolant supply port 21a from the coolant supply path 31 to the fuel cell 20 and a pressure of the coolant passing through the coolant discharge port 21b from the fuel cell 20 to the coolant discharge path 32. The differential pressure detected by the differential pressure sensor 80 is output to the controller 50.

The controller 50 includes a microcontroller including a calculation processing device (i.e., CPU), a read only memory (i.e., ROM), a random access memory (i.e., RAM) and the like. The RAM stores various types of information acquired from the pump sensor 41, the first temperature sensor 42, and the second temperature sensor 43. The controller 50 performs various functions for controlling the fuel cell system 10 based on a program stored in the ROM or the like.

For example, the controller 50 controls the coolant pump 40 to circulate the coolant between the fuel cell 20 and the coolant flow path 30. When circulating the coolant, the controller 50 controls the opening degree of the rotary valve 70 on the basis of the first coolant temperature and the second coolant temperature acquired from the first temperature sensor 42 and the second temperature sensor 43. Thus, the coolant discharged from the fuel cell 20 is appropriately cooled, and the coolant temperature of the coolant supplied to the fuel cell 20 is adjusted. Further, the controller 50 controls the coolant pump 40 to adjust a flow rate of the coolant supplied to the fuel cell 20 in accordance with amount of heat generated by the fuel cell 20. Thus, the fuel cell 20 is cooled by releasing heat generated during power generation, and can continue appropriate power generation.

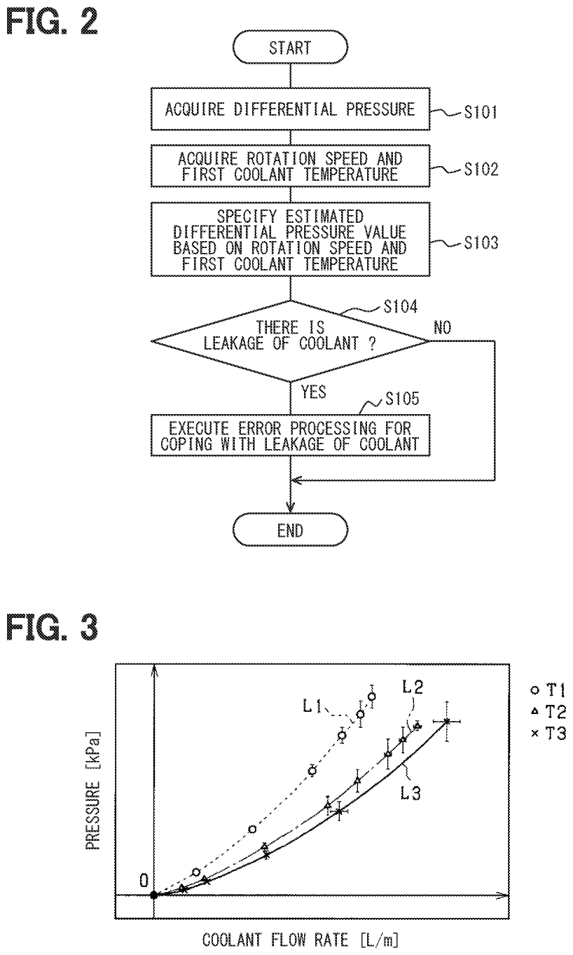

In addition, the controller 50 has a function as a determination unit that determines (detects) leakage of coolant. A detection process for detecting the leakage of the coolant will be described with reference to FIG. 2. The controller 50 executes the detection process every predetermined execution cycle.

The controller 50 acquires the differential pressure from the differential pressure sensor 80 (step S101). The controller 50 acquires the rotation speed of the coolant pump 40 and acquires the first coolant temperature from the first temperature sensor 42 (step S102).

The controller 50 specifies an estimated differential pressure value based on the rotation speed and the first coolant temperature (step S103). More specifically, the controller 50 estimates the flow rate (coolant flow rate [L/m]) of the entire coolant circulating through the coolant flow path 30 from the rotation speed. A map indicating relationships L1 to L3 between the coolant flow rate and the estimated differential pressure value as showing in FIG. 3 is stored in the ROM of the controller 50. The map is acquired by an experiment or the like and is stored in advance. Since the relationship between the coolant flow rate and the estimated differential pressure value changes depending on the first coolant temperature, the relationship between the coolant flow rate and the estimated differential pressure value is stored for each first coolant temperature. In FIG. 3, the relationship L1 when the first coolant temperature is T1 is indicated by a broken line, the relationship L2 when the first coolant temperature is T2 (>T1) is indicated by a dash-dot-dash line, and the relationship L3 when the first coolant temperature is T3 (>T2) is indicated by a solid line. In FIG. 3, types of coolant temperatures are three, but may be arbitrarily changed.

The controller 50 specifies the relationship L1 to L3 between the coolant flow rate and the estimated differential pressure value from the map based on the acquired first coolant temperature. Then, the controller 50 specifies the estimated differential pressure value from the estimated coolant flow rate with reference to the specified relationships L1 to L3.

Then, the controller 50 compares the differential pressure acquired from the differential pressure sensor 80 with the differential pressure estimated value specified in step S103 to determine whether there is leakage of the coolant (step S104). More specifically, in step S104, the controller 50 compares the differential pressure with the differential pressure estimated value, calculates a difference therebetween, and determines whether the difference is equal to or greater than a first threshold, thereby determining whether there is leakage of the coolant. That is, when the difference is equal to or greater than the first threshold, the controller 50 determines that there is leakage of the coolant.

Note that, in step S104, the controller 50 may compare the differential pressure with the differential pressure estimated value at predetermined intervals during a predetermined inspection period, calculate a difference integrated value by integrating the differences, determine whether the difference integrated value is equal to or greater than a second threshold, and determine that there is leakage of the coolant based on the result.

In addition, in step S104, the controller 50 may acquire 1 or local minimum values of the acquired difference during a predetermined inspection period, and may make a determination by comparing the local minimum values with the differential pressure estimated value.

Further, in step S104, the controller 50 may acquire the minimum value of the difference for each unit time during the inspection period, and compare the minimum value with the estimated differential pressure value to make the determination. At this time, as described above, the difference may be integrated to calculate a difference integrated value, and the determination may be made based on the difference integrated value.

When it is determined that there is a leakage of the coolant (step S104: YES), the controller 50 executes error processing for coping with the leakage of the coolant, such as lighting a warning lamp to notify that there is a leakage of the coolant (step S105). Then, the detection process is completed. On the other hand, when it is determined that there is no leakage of the coolant (step S104: NO), the controller 50 ends the detection process.

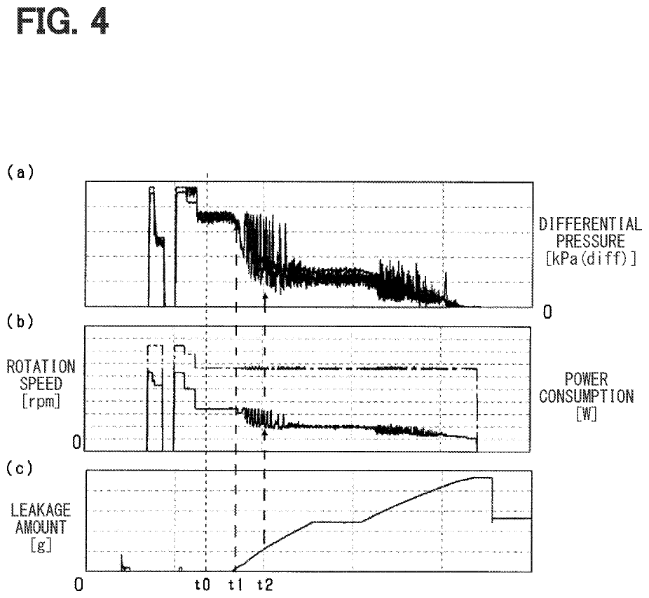

With reference to FIG. 4, how the differential pressure or the like changes when the leakage of the coolant occurs, and at what time the leakage of the coolant can be detected will be described. In FIG. 4(a), the differential pressure is indicated by a solid line. In FIG. 4(b), the rotation speed of the coolant pump 40 is indicated by a dash-dot-dash line, and the power consumption is indicated by a solid line. FIG. 4(c) shows the amount of leaking coolant. In FIG. 4, a horizontal axis represents time.

As shown in FIG. 4(b), after a time point t0, the rotation speed is constant. As shown in FIG. 4(c), when the leakage of the coolant occurs at a time point t1, the differential pressure greatly decreases as shown in FIG. 4(a). On the other hand, at a time point t1, the power consumption slightly decreases.

After, the differential pressure gradually decreases while pulsating. That is, a minimum value or a local minimum value per unit time gradually decreases. Similarly, the power consumption gradually decreases while pulsating. The rotation speed also slightly pulsates.

As described above, when the leakage of the coolant occurs, the power consumption does not greatly decrease at first, but gradually decreases with a delay. At this time, since the power consumption gradually decreases while pulsation of the power consumption occurs, the determination is difficult. On the other hand, the differential pressure decreases relatively quickly and greatly when leakage of the coolant occurs. Then, after the differential pressure greatly decreases, the pulsation of the differential pressure is started with a delay. Therefore, when the leakage of the coolant occurs, the controller 50 can quickly detect the leakage based on the differential pressure.

The first embodiment can provide the following effects.

No matter how the coolant is distributed to the radiator flow path 33 and the bypass flow path 34, the pressure of the coolant passing through the coolant supply port 21a and the pressure of the coolant passing through the coolant discharge port 21b are irrelevant. That is, regardless of how the coolant is distributed to the radiator flow path 33 and the bypass flow path 34, the entire amount of the coolant passes through the coolant supply port 21a and the coolant discharge port 21b.

Therefore, the differential pressure sensor 80 detects the differential pressure between the pressure of the coolant passing through the coolant supply port 21a and the pressure of the coolant passing through the coolant discharge port 21b, and the controller 50 determines the leakage of the coolant based on the comparison between the differential pressure and the differential pressure estimated value. Therefore, abnormality, for example the leakage of the coolant, of the fuel cell system 10 can be always determined. Further, as shown in FIG. 4, the differential pressure rapidly decreases when the leakage of the coolant occurs compared to the power consumption. Therefore, quickly detect is capable of the leakage of the coolant.

As shown in FIG. 4, when the leakage of the coolant occurs, the differential pressure decreases while pulsating. Therefore, depending on the detection timing of the differential pressure, there is a possibility that the differential pressure is acquired when the differential pressure is high and erroneous determination is made. Therefore, in step S104, the controller 50 may compare the differential pressure and the differential pressure estimated value at the predetermined intervals during the inspection period, calculate a difference integrated value by integrating the differences, determine whether the difference integrated value is equal to or greater than a second threshold, and determine that there is leakage of the coolant based on the result.

Alternatively, in step S104, the controller 50 may acquire 1 or local minimum values of the acquired difference during the inspection period, and may make a determination by comparing the local minimum values with the differential pressure estimated value. Further, in step S104, the controller 50 may acquire the minimum value of the difference for each unit time during the inspection period, and compare the minimum value with the estimated differential pressure value to make the determination. At this time, as described above, the difference may be integrated to calculate a difference integrated value, and the determination may be made based on the difference integrated value. By performing any of these methods in step S104, decrease of determination accuracy can be suppressed, even if the differential pressure decreases while pulsating when the leakage of the coolant occurs.

The estimated differential pressure value is set according to the first coolant temperature and the rotation speed. More specifically, the controller 50 estimates the coolant flow rate from the rotation speed, and specifies the relationship L1 to L3 between the coolant flow rate and the estimated differential pressure value from the map illustrated in FIG. 3 based on the first coolant temperature. Then, the controller 50 specifies the estimated differential pressure value from the estimated coolant flow rate with reference to the specified relationships L1 to L3. Therefore, even when the first coolant temperature or the rotation speed changes, the leakage of the coolant is determined using the differential pressure estimated value corresponding to the change, and thus erroneous determination can be suppressed. Further, even when the rotation speed is changed, since the differential pressure estimation value corresponding to the change is used, setting the rotation speed to a predetermined speed for inspection is not necessary. That is, the controller 50 can always determine the leakage of the refrigerant.

The controller 50 determines based on the difference between the differential pressure and the differential pressure estimated value. Therefore, the controller 50 is not necessary to determine a magnitude relationship between the differential pressure and the differential pressure estimated value in order to determine the leakage of the coolant, and the processing becomes simple. Further, pressure loss can be reduced as compared with a case where a flow rate sensor for measuring the coolant flow rate is provided inside the coolant flow path 30. Further, since change in the coolant pressure can be detected earlier than the change in the coolant flow rate, the leakage of the coolant can be detected quickly.

### Second Embodiment

In the first embodiment, the leakage of the coolant is detected based on the differential pressure between the coolant passing through the coolant supply port 21a of the fuel cell 20 and the coolant passing through the coolant discharge port 21b. In a second embodiment, a pressure of the coolant in any portion of a coolant flow path 30 is detected, and a leakage of the coolant is detected based on a detected coolant pressure. This will be described below in detail.

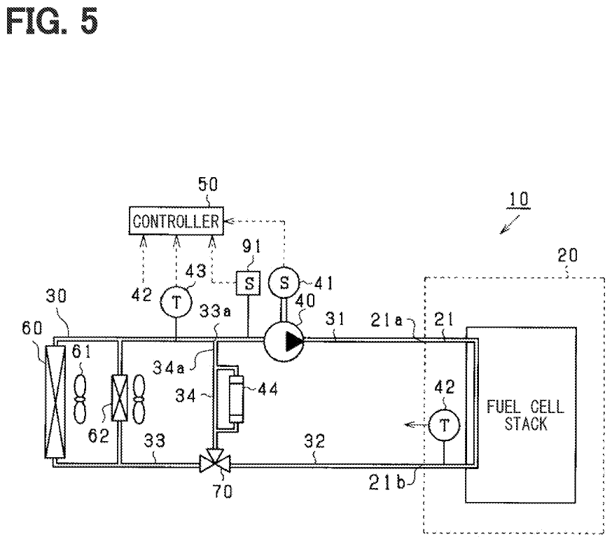

As shown in FIG. 5, a first pressure sensor 91 is provided in a coolant supply path 31 of the coolant flow path 30. The first pressure sensor 91 detects a first coolant pressure passing through a vicinity of an inflow port of a coolant pump 40 in the coolant supply path 31. The first coolant pressure detected by the first pressure sensor 91 is output to a controller 50.

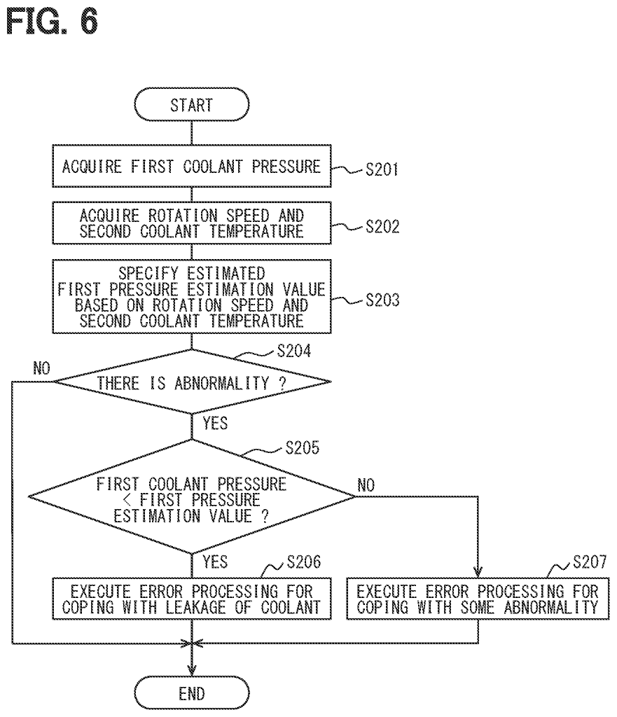

A detection process for detecting the leakage of the coolant of the second embodiment will be described with reference to FIG. 6. The controller 50 executes the detection process every predetermined execution cycle. The controller 50 acquires the first coolant pressure from the first pressure sensor 91 (step S201). The controller 50 acquires rotation speed of the coolant pump 40 and acquires a temperature (hereinafter, a second coolant temperature) of the coolant in the coolant supply path 31 from a second temperature sensor 43 (step S202).

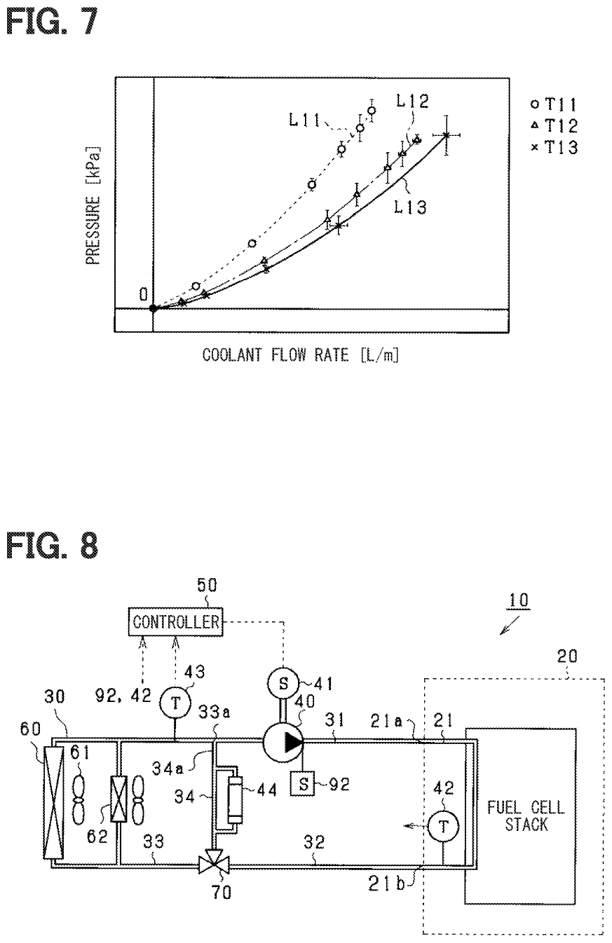

The controller 50 specifies a pressure estimation value (hereinafter, a first pressure estimation value) of a first coolant pressure passing through a vicinity of the inflow port of the coolant pump 40 based on the rotation speed and the second coolant temperature (step S203). More specifically, the controller 50 estimates a coolant flow rate from the rotation speed. A map indicating the relationship L11 to L13 between the coolant flow rate and the first pressure estimation value as showing in FIG. 7 is stored in the ROM of the controller 50. The map is acquired by an experiment or the like and is stored in advance. Since the relationship between the coolant flow rate and the first estimated pressure value changes depending on the second coolant temperature, the relationship between the coolant flow rate and the first estimated pressure value is stored for each second coolant temperature. In FIG. 7, the relationship L11 when the second coolant temperature is a temperature T11 is indicated by a broken line, the relationship L12 when the second coolant temperature is a temperature T12 (>T11) is indicated by a dash-dot-dash line, and the relationship L13 when the second coolant temperature is a temperature T13 (>T12) is indicated by a solid line. In FIG. 7, types of coolant temperatures are three, but may be arbitrarily changed.

The controller 50 specifies the relationship L11 to L13 between the coolant flow rate and the first pressure estimation value from the map based on the acquired second coolant temperature. Then, the controller 50 specifies the first pressure estimation value from the estimated coolant flow rate with reference to the specified relationships L11 to L13.

Then, the controller 50 compares the first coolant pressure acquired from the first pressure sensor 91 with the first pressure estimation value specified in step S203, and determines whether there is an abnormality (step S204). Although there is a difference between the first coolant pressure and the differential pressure, and a difference between the first pressure estimation value and the differential pressure estimation value, the determination method is substantially the same as the description in step S104 described above, and thus the description in step S104 is used instead, and the detailed description is omitted.

When it is determined that there is an abnormality (step S204: YES), the controller 50 determines whether the first coolant pressure is lower than the first pressure estimation value (step S205). When it is determined that the first coolant pressure is lower than the first pressure estimation value (step S204: YES), the controller 50 determines that the leakage of the coolant occurs, and executes error processing for coping with the leakage of the coolant (step S206). Then, the detection process is completed. In step S206, when the first coolant pressure is a negative pressure, the controller 50 may estimate a leakage location based on a magnitude of the negative pressure. That is, a pressure at the leakage location is the same as an atmospheric pressure (Usually, 0 kPa), and the longer a distance from the leakage location to the first pressure sensor 91, the larger the negative pressure. Therefore, a position of the leakage location may be estimated by estimating the distance from the leakage location to the first pressure sensor 91 based on the magnitude of the negative pressure.

On the other hand, when it is determined that the first coolant pressure is higher than the first pressure estimation value (step S205: NO), the controller 50 determines that some abnormality has occurred, and executes error processing (step S207). Then, the detection process is completed. It is considered that some abnormality occurs, for example, an abnormality in which the coolant flow path 30 is blocked at any position, an abnormality in which the rotary valve 70 is fixed, or an abnormality in which cavitation occurs. When it is determined that there is no abnormality (step S204: NO), the controller 50 ends the detection process.

The second embodiment can provide the following effects.

Regardless of how the coolant is distributed to the radiator flow path 33 and the bypass flow path 34, all the coolant passes through the inflow port of the coolant pump 40. Therefore, the controller 50 detects the first coolant pressure passing through the vicinity of the inflow port of the coolant pump 40, and determines an abnormality based on the first coolant pressure. Therefore, the controller 50 can always determine whether the coolant is normally supplied to the fuel cell 20. Further, since only the first coolant pressure is detected, the configuration can be simplified as compared with a configuration of detecting the differential pressure.

In addition, in step S204, similarly to step S104, by using a difference integrated value, a minimum value, or a local minimum value, decrease of determination accuracy can be suppressed even when the first coolant pressure decreases while pulsating when the coolant leakage occurs.

The first estimated pressure value is set according to the second coolant temperature and the rotation speed. Therefore, even when the second coolant temperature or the rotation speed changes, erroneous determination can be suppressed using the first pressure estimation value corresponding to the change. In addition, even when the rotation speed is changed, since the first pressure estimation value corresponding to the change is used, setting the rotation speed to a predetermined speed for inspection is not necessary. That is, the controller 50 can always determine the leakage of the refrigerant.

In step S206, when the first coolant pressure passing through the vicinity of the inflow port of the coolant pump 40 is the negative pressure, the controller 50 can estimate the leakage location based on the magnitude of the negative pressure. Therefore, when the leakage of the coolant occurs, repair can be easily performed. In addition, when it is determined that the first coolant pressure is higher than the first pressure estimation value, the controller 50 can determine that any one of an abnormality that the coolant flow path 30 is blocked at any place, an abnormality that the rotary valve 70 is stuck, and an abnormality that cavitation occurs has occurred. Therefore, the abnormal portion can be easily specified.

### Third Embodiment

In a third embodiment, unlike the second embodiment, a pressure of a coolant passing through a vicinity of an outlet port of a coolant pump 40 is detected. Hereinafter, differences from the second embodiment will be mainly described.

As shown in FIG. 8, a second pressure sensor 92 is provided in a coolant supply path 31 of the coolant flow path 30. The second pressure sensor 92 detects a second coolant pressure passing through a vicinity of the outlet port of the coolant pump 40 in the coolant supply path 31. The second coolant pressure detected by the second pressure sensor 92 is output to a controller 50.

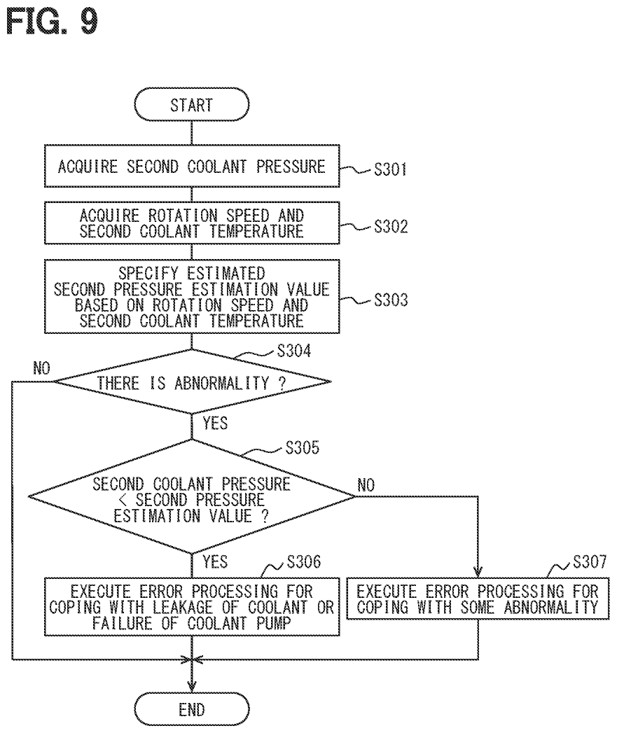

A detection process for detecting a leakage of a coolant of the third embodiment will be described with reference to FIG. 9. Steps S301 to S304 include a difference between the first refrigerant pressure and the second refrigerant pressure, and a difference between the first estimated pressure value and the second estimated pressure value, but other descriptions are substantially the same as those of the second embodiment, and thus descriptions thereof are omitted. A second pressure estimation value is a pressure estimation value of the second coolant pressure passing through the vicinity of the outlet port of the coolant pump 40.

When it is determined that there is an abnormality (step S304: YES), the controller 50 determines whether the second coolant pressure is lower than the second pressure estimation value (step S305). When it is determined that the second coolant pressure is lower than the second pressure estimation value (step S305: YES), the controller 50 determines that the leakage of the coolant or the failure of the coolant pump 40 has occurred, and executes error processing for coping with the abnormality (step S306).

On the other hand, when it is determined that the second coolant pressure is higher than the second pressure estimation value (step S305: NO), the controller 50 determines that some abnormality has occurred, and executes error processing (step S307). The abnormality is considered to be an abnormality in which the coolant flow path 30 is clogged or an abnormality in which the rotary valve 70 is fixed. When it is determined that there is no abnormality (step S304: NO), the controller 50 ends the detection process.

The third embodiment can provide the following effects.

Regardless of how the coolant is distributed to a radiator flow path 33 and a bypass flow path 34, all the coolant passes through the outlet port of the coolant pump 40. Therefore, the controller 50 detects the second coolant pressure passing through the vicinity of the outlet port of the coolant pump 40, and determines an abnormality based on the second coolant pressure. Therefore, the controller 50 can always determine whether the coolant is normally supplied to the fuel cell 20. Further, since only the second coolant pressure is detected, the configuration can be simplified as compared with a configuration of detecting the differential pressure.

In addition, in step S304, similarly to step S104, by using a difference integrated value, a minimum value, or a local minimum value, decrease of determination accuracy can be suppressed even when the second coolant pressure decreases while pulsating when the coolant leakage occurs.

The second estimated pressure value is set according to the second coolant temperature and the rotation speed. Therefore, even when the second coolant temperature or the rotation speed changes, erroneous determination can be suppressed using the second pressure estimation value corresponding to the change. In addition, even when the rotation speed is changed, since the second pressure estimation value corresponding to the change is used, setting the rotation speed to a predetermined speed for inspection is not necessary. That is, the controller 50 can always determine the leakage of the refrigerant.

When it is determined that the second coolant pressure is higher than the second pressure estimation value, the controller 50 can determine that an abnormality in which the coolant flow path 30 is clogged at any place or an abnormality in which the rotary valve 70 is stuck occurs. Therefore, the abnormal portion can be easily specified.

### Fourth Embodiment

In a fourth embodiment, unlike the second embodiment, a pressure of a coolant passing through a vicinity of a coolant supply port 21a of a fuel cell 20 is detected. Hereinafter, differences from the second embodiment will be mainly described.

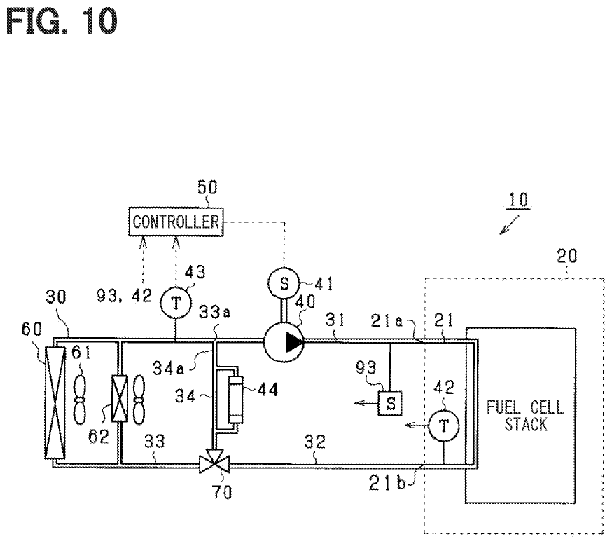

As shown in FIG. 10, a third pressure sensor 93 is provided in a coolant supply path 31 of a coolant flow path 30. The third pressure sensor 93 detects a pressure of the coolant passing through the vicinity of the coolant supply port 21a of the fuel cell 20 in the coolant supply path 31. Hereinafter, the pressure is referred to as a third coolant pressure. The third coolant pressure detected by the third pressure sensor 93 is output to a controller 50.

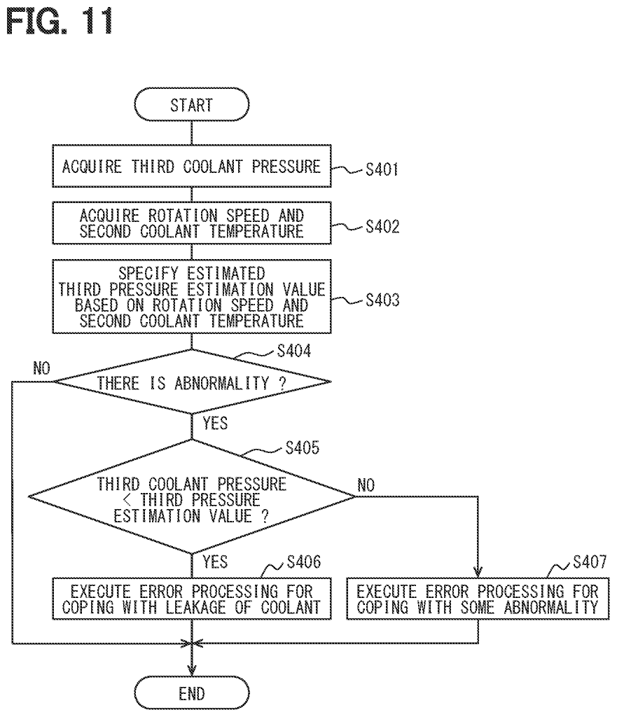

A detection process for detecting a leakage of the coolant of the fourth embodiment will be described with reference to FIG. 11. Steps S401 to S404 include a difference between a first coolant pressure and the third coolant pressure, and a difference between a first estimated pressure value and a third estimated pressure value, but other descriptions are substantially the same as those of the second embodiment, and thus descriptions thereof are omitted. The third estimated pressure value is a pressure estimated value of the third coolant pressure passing through the vicinity of the coolant supply port 21a of the fuel cell 20.

When it is determined that there is an abnormality (step S404: YES), the controller 50 determines whether the third coolant pressure is lower than the third pressure estimation value (step S405). When it is determined that the third coolant pressure is lower than the third pressure estimation value (step S405: YES), the controller 50 determines that the leakage of the coolant occurs, and executes error processing for coping with the leakage of the coolant (step S406). In addition, in this case, the controller 50 can specify that leakage of the coolant occurs between the outlet port of the coolant pump 40 and the coolant supply port 21a of the fuel cell 20. In addition, the controller 50 can estimate that a flow rate of the coolant supplied to the fuel cell 20 is low.

On the other hand, when it is determined that the third coolant pressure is higher than the third pressure estimation value (step S405: NO), the controller 50 determines that some abnormality has occurred, and executes error processing (step S407). The abnormality is considered to be an abnormality in which the coolant flow path 30 is clogged or an abnormality in which the rotary valve 70 is fixed. When it is determined that there is no abnormality (step S404: NO), the controller 50 ends the detection process.

According to the fourth embodiment, effects similar to the effects of the third embodiment can be obtained. In addition, in the fourth embodiment, when it is determined that the third coolant pressure is lower than the third pressure estimation value, the controller 50 can specify that leakage of coolant occurs between the outlet port of the coolant pump 40 and the coolant supply port 21a of the fuel cell 20. In addition, the controller 50 can estimate that a flow rate of the coolant supplied to the fuel cell 20 is low.

### Fifth Embodiment

In the first embodiment, the leakage of the coolant is detected based on the differential pressure between the coolant passing through the coolant supply port 21a of the fuel cell 20 and the coolant passing through the coolant discharge port 21b. In a fifth embodiment, pressures of the coolant in three portions of a coolant flow path 30 are detected, and a leakage of the coolant is detected based on detected coolant pressures. This will be described below in detail.

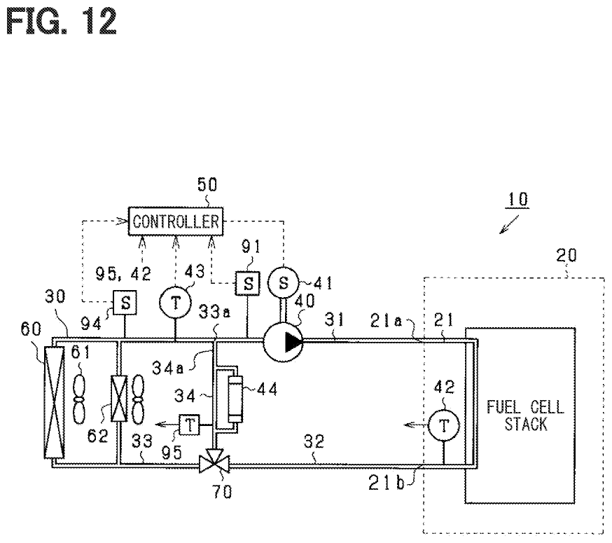

As shown in FIG. 12, a first pressure sensor 91 is provided in a coolant supply path 31 of a coolant flow path 30. The first pressure sensor 91 detects a first coolant pressure passing through a vicinity of an inflow port of a coolant pump 40 in the coolant supply path 31. A fourth pressure sensor 94 is provided in a radiator flow path 33. The fourth pressure sensor 94 detects a pressure of the coolant passing through a vicinity of an end portion on the coolant supply path 31 of the radiator 60 in the radiator flow path 33. The fourth pressure sensor 94 is shifted from the radiator 60 toward the coolant supply path 31. Hereinafter, the pressure is referred to as a fourth refrigerant pressure.

A fifth pressure sensor 95 is provided in a bypass flow path 34. The fifth pressure sensor 95 detects a pressure of the coolant passing near an end portion on the coolant supply path 31 (the end portion opposite to the rotary valve 70) in the bypass flow path 34. Hereinafter, the pressure is referred to as a fifth coolant pressure. Each detected coolant pressure is output to the controller 50.

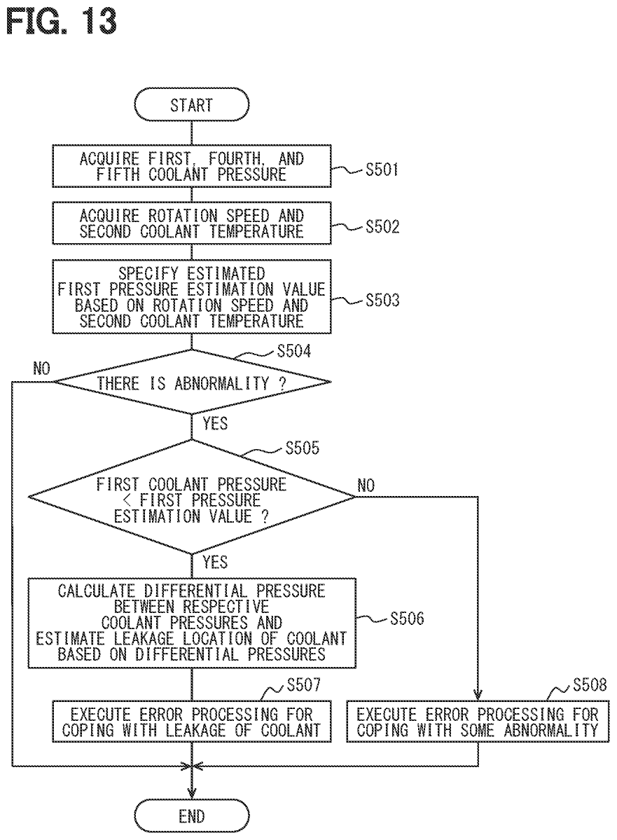

A detection process for detecting a leakage of the coolant of the fifth embodiment will be described with reference to FIG. 13. The controller 50 executes the detection process every predetermined execution cycle.

The controller 50 acquires the respective coolant pressures from the first pressure sensor 91, the fourth pressure sensor 94, and the fifth pressure sensor 95 (step S501). In addition, the controller 50 acquires a rotation speed of the coolant pump 40 and acquires a second coolant temperature (step S502).

The controller 50 specifies the first pressure estimation value based on the rotation speed and the second coolant temperature in the same manner as in step S203 in the second embodiment (step S503). Then, the controller 50 compares the first coolant pressure with the first estimated pressure value in the same manner as in step S204, and determines whether there is an abnormality (step S504).

When it is determined that there is an abnormality (step S504: YES), the controller 50 determines whether the first coolant pressure is lower than the first pressure estimation value (step S505). When it is determined that the first coolant pressure is lower than the first pressure estimation value (step S505: YES), the controller 50 determines that the leakage of the coolant occurs, calculates a differential pressure between the respective coolant pressures acquired in step S501, and estimates a leakage location of the coolant based on the differential pressure (step S506). In step S506, the controller 50 compares a differential pressure between the first coolant pressure and the fourth coolant pressure with a differential pressure between the first coolant pressure and the fifth coolant pressure to estimate distribution amounts (estimated distribution amounts) between a flow rate of the coolant passing through the radiator flow path 33 and a flow rate of the coolant passing through the bypass flow path 34. Further, the controller 50 specifies actual distribution amounts based on an opening degree of the rotary valve 70.

Then, the controller 50 compares the estimated distribution amounts with the actual distribution amounts, and when a ratio of the flow rate of the coolant passing through the radiator flow path 33 is low, the controller 50 estimates that the leakage occurs at any portion of the radiator flow path 33. On the other hand, when the ratio of the flow rate of the coolant passing through the bypass flow path 34 is low, the controller 50 estimates that the leakage occurs at any portion of the bypass flow path 34. Further, when the estimated distribution amounts and the actual distribution amounts do not change, the controller 50 estimates that the leakage occurs in any of the coolant supply path 31, the coolant discharge path 32, and the in-cell flow path 21. The estimated location is notified to or stored in an external device or the like. In step S506, when the first coolant pressure is a negative pressure, the controller 50 may estimate a distance to the leakage location based on a magnitude of the negative pressure in the same manner as in step S206. Thereafter, an error process for coping with the leakage of the coolant is executed (step S507).

On the other hand, when it is determined that the first coolant pressure is higher than the first pressure estimation value (step S505: NO), the controller 50 determines that some abnormality has occurred, and executes error processing (step S508). It is considered that some abnormality occurs, for example, an abnormality in which the coolant flow path 30 is blocked at any position, an abnormality in which the rotary valve 70 is fixed, or an abnormality in which cavitation occurs. When it is determined that there is no abnormality (step S504: NO), the controller 50 ends the detection process.

In the fifth embodiment, the following effects can be obtained in addition to the same effects as those of the second embodiment. That is, when the controller 50 determines that the leakage of the coolant occurs, the controller 50 can estimate whether the leakage of the coolant occurs at any portion of the coolant flow path 30 based on the differential pressure between the first coolant pressure and the fourth coolant pressure and the differential pressure between the first coolant pressure and the fifth coolant pressure. Accordingly, time and effort for repair can be reduced. In addition, when the distance to the leakage location is estimated based on the magnitude of the negative pressure, the leakage location can be further easily specified.

### Other Embodiments

In the above embodiments, when a rotation speed is changed, a pressure of a coolant changes accordingly. For this reason, in a case where an abnormality such as leakage of the coolant is determined based on a differential pressure or a coolant pressure, if a change timing of the rotation speed and a determination timing overlap with each other, determination accuracy may decrease. Therefore, in the above embodiments, when a controller 50 determine that an abnormality including the leakage of the coolant or the like occurs, an inspection period in which the rotation speed is constant may be set, and the controller 50 may determine whether an abnormality occurs again in the inspection period. Accordingly, the determination efficiency can be improved.

In the first embodiment, when the flow rate of the coolant flowing through the coolant flow path 30 is close to 0, the differential pressure is also close to 0. In this case, even if the leakage of the coolant does not occur, the controller 50 may erroneously determine that the leakage of the coolant occurs. Therefore, in the first embodiment, when the controller 50 determines that the leakage of the coolant occurs when the differential pressure is equal to or less than a predetermined value, the controller 50 may temporarily increase the rotation speed of the coolant pump 40, acquire the differential pressure again, and determine whether the leakage of the coolant occurs. That is, by increasing the rotation speed, the coolant flow rate increases and the differential pressure also increases. Therefore, the determination accuracy can be improved.

In the first embodiment, when the rotation speed is equal to or less than a predetermined number, that is, when the flow rate of the coolant is equal to or less than a predetermined amount, as showing in FIG. 3 and the like, a value of the differential pressure itself becomes small, and the difference from the differential pressure becomes small even when the leakage of the coolant occurs. That is, possibility of erroneous determination increases. Therefore, in the first embodiment, when the controller 50 determines that the leakage of the coolant occurs when the rotation speed is equal to or less than a predetermined number, the controller 50 may temporarily increase the rotation speed of the coolant pump 40, acquire the differential pressure again, and determine whether the leakage of the coolant occurs. That is, by increasing the rotation speed, the coolant flow rate increases and the differential pressure also increases. Therefore, the determination accuracy can be improved.

In the first embodiment, when the rotation speed is equal to or less than a predetermined number, that is, when the flow rate of the coolant is equal to or less than a predetermined amount, as showing in FIG. 3 and the like, a value of the differential pressure itself becomes small, and the difference from the differential pressure becomes small even when the leakage of the coolant occurs. That is, possibility of erroneous determination increases. Therefore, in step S104, various thresholds (the first threshold and the second threshold) may be corrected according to the rotation speed. That is, the various thresholds may be corrected to be smaller as the rotation speed is smaller. Accordingly, the determination efficiency can be improved.

In step S104 of the first embodiment, the various thresholds (the first threshold and the second threshold) may be corrected according to the first coolant temperature. Accordingly, erroneous determination due to a difference in the first coolant temperature can be suppressed.

In the second to fifth embodiments, when the rotation speed is equal to or less than a predetermined number, that is, when the flow rate of the coolant is equal to or less than a predetermined amount, as showing in FIG. 7 and the like, a value of the coolant pressure itself becomes small, and the difference from the coolant pressure becomes small even when an abnormality occurs. That is, possibility of erroneous determination increases. Therefore, when the controller 50 determines that an abnormality has occurred when the rotation speed is equal to or less than a predetermined number, the controller 50 may temporarily increase the rotation speed of the coolant pump 40, acquire the coolant pressure again, and determine whether an abnormality has occurred. That is, by increasing the rotation speed, the coolant flow rate increases and the coolant pressure also increases. Therefore, the determination accuracy can be improved.

In the second to fifth embodiments, when the rotation speed is equal to or less than a predetermined number, that is, when the flow rate of the coolant is equal to or less than a predetermined amount, as showing in FIG. 7 and the like, a value of the coolant pressure itself becomes small, and the difference from the coolant pressure becomes small even when an abnormality occurs. That is, possibility of erroneous determination increases. Therefore, in steps S204, S304, S404, and S504, the various thresholds (the first threshold and the second threshold) may be corrected according to the rotation speed. That is, the various thresholds may be corrected to be smaller as the rotation speed is smaller. Accordingly, the determination efficiency can be improved.

In steps S204, S304, S404, and S504 of the second to fifth embodiments, the various thresholds (the first threshold and the second threshold) may be corrected according to the second coolant temperature. Accordingly, erroneous determination due to a difference in the second coolant temperature can be suppressed.

In step S104, step S204, step 304, step 404, and step S504 of the above embodiments, the local minimum value may be specified by differentiation.

In the first embodiment, when no abnormality occurs, the pressure of the coolant passing through the coolant discharge path 32 generally does not substantially fluctuate and is in a stable state. Therefore, the pressure of the coolant passing through the coolant discharge path 32 is detected by a pressure sensor or the like. Then, when the coolant pressure passing through the coolant discharge path 32 fluctuates with the coolant flow rate, or when the coolant pressure continues to be in a range of the atmospheric pressure (within a predetermined range), the controller 50 may estimate that an abnormality (failure or disconnection) of the differential pressure sensor 80 has occurred. In such a case, the controller 50 may increase the rotation speed to more accurately determine whether an abnormality has occurred in the differential pressure sensor 80.

In the above embodiments, the first pressure sensor 91 and the second pressure sensor 92 may acquire the first coolant pressure passing through the inflow port and the second coolant pressure passing through the outlet port of the coolant pump 40, calculate the differential pressure between the first coolant pressure and the second coolant pressure, and determine failure of the coolant pump 40 based on the differential pressure. whether the flow rate of the coolant supplied to the fuel cell 20 is sufficient may be determined based on the differential pressure.

In the first embodiment, the determination is made based on the comparison between the differential pressure and the differential pressure estimated value. However, as another example, the controller 50 may determine that the leakage has occurred in a case where the differential pressure drops sharply by a determination threshold or more even though the rotation speed is the same. The determination threshold may be set in accordance with rotation speed and the coolant temperature.

In the second embodiment, the determination is made based on the comparison between the coolant pressure and the estimated pressure value. However, as another example, the controller 50 determine that the leakage has occurred in a condition where the coolant pressure drops sharply by a determination threshold or more even though the rotation speed is the same. The determination threshold may be set in accordance with rotation speed and the coolant temperature.

In the fifth embodiment, coolant pressures at four or more locations may be detected, a differential pressure between the detected coolant pressures may be calculated, and the coolant leakage location may be estimated.

In the fifth embodiment, when the controller 50 estimates that the estimated leakage location occurs in one of the radiator flow path 33 and the bypass flow path 34, the controller 50 may control the rotary valve 70 so that all the coolant flows in the other flow path in which it is estimated that the leakage location does not occur. Accordingly, abnormality processing (power generation restriction or the like) of the fuel cell 20 can be delayed.

In the fifth embodiment, when the controller 50 determines that the leakage of the coolant occurs, the controller 50 may control the rotary valve 70 by correcting distribution amounts based on a deviation of the coolant temperature (a deviation between a set value and an actual temperature) and a shortage of the distribution amounts based on the leakage. For example, when the coolant temperature is higher than a set value for a reason that a leakage occurs in the radiator flow path 33 and the flow rate of the coolant flowing through the radiator flow path 33 is small, the distribution amounts to the radiator flow path 33 may be corrected such that the distribution amounts increase. Accordingly, abnormality processing (power generation restriction or the like) of the fuel cell 20 can be delayed.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A battery system configured to cool a battery device by supplying a coolant to the battery device, the battery system comprising:
a coolant flow path through which the coolant circulates;
a coolant pump configured to control a flow of the coolant passing through the coolant flow path to circulate the coolant between the battery device and the coolant flow path;
a differential pressure sensor configured to detect a differential pressure between a pressure of the coolant passing through a coolant supply port from the coolant flow path to the battery device and a pressure of the coolant passing through a coolant discharge port from the battery device to the coolant flow path; and
a determination unit configured to determine whether there is a leakage of the coolant based on a comparison between the differential pressure acquired from the differential pressure sensor and an estimated value stored in advance, wherein
the determination unit is configured to:
obtain differences within each interval of a predetermined unit time, each of the differences is a difference between the differential pressure and the estimated value and obtained by comparing the differential pressure acquired from the differential pressure sensor with the estimated value stored in advance;
obtain minimum values within a predetermined inspection period, each of the minimum values is a minimum value among the differences obtained;
calculate a difference integrated value by integrating the minimum values; and
determine whether there is the leakage of the coolant based on the difference integrated value.

2. A battery system configured to cool a battery device by supplying a coolant to the battery device, the battery system comprising:
a coolant flow path through which the coolant circulates;
a coolant pump configured to control a flow of the coolant passing through the coolant flow path to circulate the coolant between the battery device and the coolant flow path;
a differential pressure sensor configured to detect a differential pressure between a pressure of the coolant passing through a coolant supply port from the coolant flow path to the battery device and a pressure of the coolant passing through a coolant discharge port from the battery device to the coolant flow path; and
a determination unit configured to determine whether there is a leakage of the coolant based on a comparison between the differential pressure acquired from the differential pressure sensor and an estimated value stored in advance, wherein,
the determination unit is configured to increase a rotation speed of the coolant pump and then newly determine whether there is the leakage of the coolant when the determination unit has determined that there is the leakage of the coolant in a condition where a difference between the differential pressure and the estimated value is equal to or less than a predetermined value.

3. The battery system according to claim 1, further comprising
a temperature sensor configured to detect a coolant temperature of the coolant, wherein
the estimated value is set according to the coolant temperature and a rotation speed of the coolant pump.

4. A battery system configured to cool a battery device by supplying a coolant to the battery device, the battery system comprising:
a coolant flow path through which the coolant circulates;
a coolant pump configured to control a flow of the coolant passing through the coolant flow path to circulate the coolant between the battery device and the coolant flow path;
a pressure sensor configured to detect a pressure of the coolant passing through the coolant flow path; and
a determination unit configured to determine whether there is a leakage of the coolant based on the pressure acquired from the pressure sensor, wherein,
the determination unit is configured to increase a rotation speed of the coolant pump and then newly determine whether there is the leakage of the coolant when the determination unit has determined that there is the leakage of the coolant in a condition where a difference between the differential pressure and the estimated value is equal to or less than a predetermined value.

5. The battery system according to claim 4, wherein
the pressure sensor is configured to detect at least a pressure of the coolant passing through an outlet of the coolant pump, and
the determination unit is configured to determine whether there is the leakage of the coolant and an abnormality in the coolant pump based on the pressure of the coolant passing through the outlet of the coolant pump.

6. The battery system according to claim 4, wherein
the pressure sensor is configured to detect at least a pressure of the coolant passing through a coolant supply port from the coolant flow path to the battery device, and
the determination unit is configured to determine whether there is the leakage of the coolant and whether a flow rate of the coolant supplied to the battery device is appropriate based on the pressure of the coolant passing through the coolant supply port.

7. The battery system according to claim 4, wherein
the pressure sensor is configured to detect at least a pressure of the coolant passing through an inlet of the coolant pump, and
the determination unit configured to determine whether there is the leakage of the coolant and estimate a leakage location based on the pressure of the coolant passing through the inlet of the coolant pump.

8. The battery system according to claim 4, wherein
the pressure sensor is configured to detect at least a pressure of the coolant passing through an inlet of the coolant pump and a pressure of the coolant passing through an outlet of the coolant pump, and
the determination unit is configured to specify an abnormality of the coolant pump based on the pressure of the coolant passing through the inlet and the pressure of the coolant passing through the outlet.

9. The battery system according to claim 4, wherein
the pressure sensor is configured to detect at least pressures of the coolant at three or more detection points of the coolant flow path,
the determination unit is configured to:
calculate differential pressures between the detection points based on the detected pressures; and
estimate a leakage location based on the differential pressures between the detection points.

10. The battery system according to claim 9, wherein
the coolant flow path includes a radiator flow path including a radiator, a bypass flow path provided in parallel with the radiator flow path,
the battery system further comprises:
a valve device configured to distribute the coolant discharged from the battery device to the radiator flow path and the bypass flow path; and
a controller configured to control the valve device, and
the controller controls the valve device such that all the coolant flows in one of flow paths that are the radiator flow path and the bypass flow path when the determination unit has estimated that the leakage location is not in a path within the battery device and the one of the flow paths but in the other of the flow paths.

11. The battery system according to claim 6, wherein
the coolant flow path includes a radiator flow path including a radiator, and
a bypass flow path provided in parallel with the radiator flow path,
the battery system comprises:
a valve device configured to distribute the coolant discharged from the battery device to the radiator flow path and the bypass flow path; and
a controller configured to control the valve device, wherein
the pressure sensor is configured to detect at least pressures of the coolant at three or more detection points of the coolant flow path, and
the determination unit is configured to:
calculate differential pressures between the detection points based on the detected pressures; and
estimate distribution amounts of the coolant flowing through the radiator flow path and the bypass flow path based on the differential pressures between the detection points,
the controller is configured to control the valve device by correcting the distribution amounts based on a deviation of the coolant temperature and a shortage of a coolant flow rate based on a leakage.
